(19) United States
(12) Patent Application Publication
(10) Pub. No.: US 2013/0242104 A1
(43) Pub. Date: Sep. 19, 2013

(54) TRAFFIC MONITORING SYSTEM AND METHOD FOR MONITORING ROADWAY CONDITION

(71) Applicants: GDS SOFTWARE (SHENZHEN) CO., LTD, Shenzhen (CN); HON HAI PRECISION INDUSTRY CO., LTD., New Taipei (TW)

(72) Inventors: Chi-Chih WANG, Tu-Cheng (TW); Tzu-Te WANG, Tu-Cheng (TW); KaiI-Chiang YANG, Tu-Cheng (TW)

(73) Assignees: HON HAI PRECISION INDUSTRY CO., LTD., New Taipei (TW); GDS Software (ShenZhen) Co., Ltd, Shenzhen (CN)

(21) Appl. No.: 13/662,006

(22) Filed: Oct. 26, 2012

(30) Foreign Application Priority Data
Mar. 16, 2012 (CN) 201210069371.6

(51) Int. Cl. H04N 7/18

(52) U.S. Cl. 348/149; 348/E07.085

(57) ABSTRACT

A traffic monitoring system includes a plurality of cameras, a monitor center and a portable electronic device. The cameras are respectively positioned at a plurality of monitoring regions to obtain images of the monitoring regions. The monitor center receives the images of the monitoring regions from the cameras and determines a traffic information in the monitoring regions according to the images. The portable electronic device is communicated with the monitor center and receives the traffic information from the monitor center. A method for monitoring a roadway condition is also provided.

### BACKGROUND

1. Technical Field

The disclosure generally relates to a traffic monitoring system and a method for monitoring roadway conditions.

2. Description of Related Art

Nowadays, due to an increasing of cars, traffic jams are happened frequently, especially in a commuter time. However, before starting off, a driver can not obtain an instant roadway condition of roads. If the road the driver selected is in traffic jam, the driver will spend a lot of time to get to a destination.

What is needed, therefore, is a traffic monitoring system and a method for monitoring a roadway condition which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a traffic monitoring system in accordance with one embodiment of the disclosure.

FIG. 2 is a schematic view showing an operation environment of the traffic monitoring system in FIG. 1.

### DETAILED DESCRIPTION

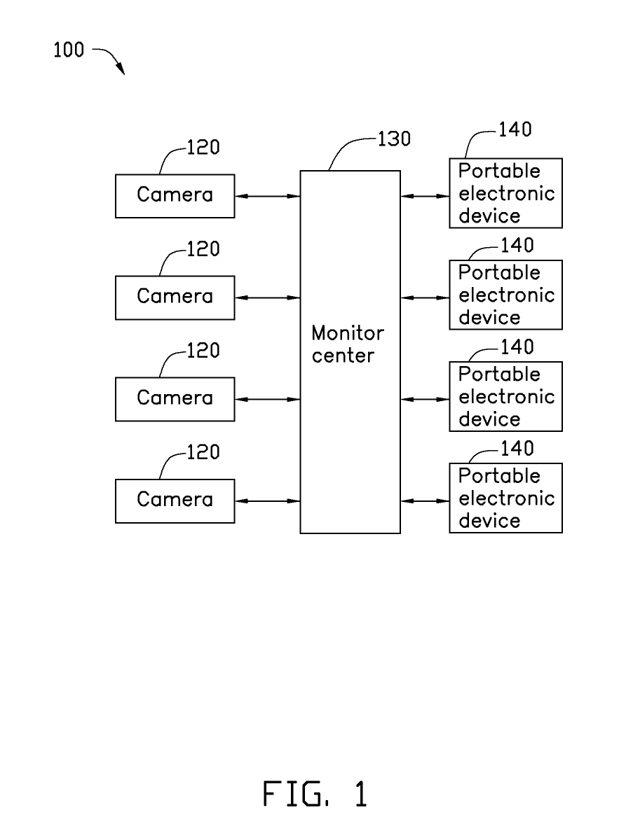

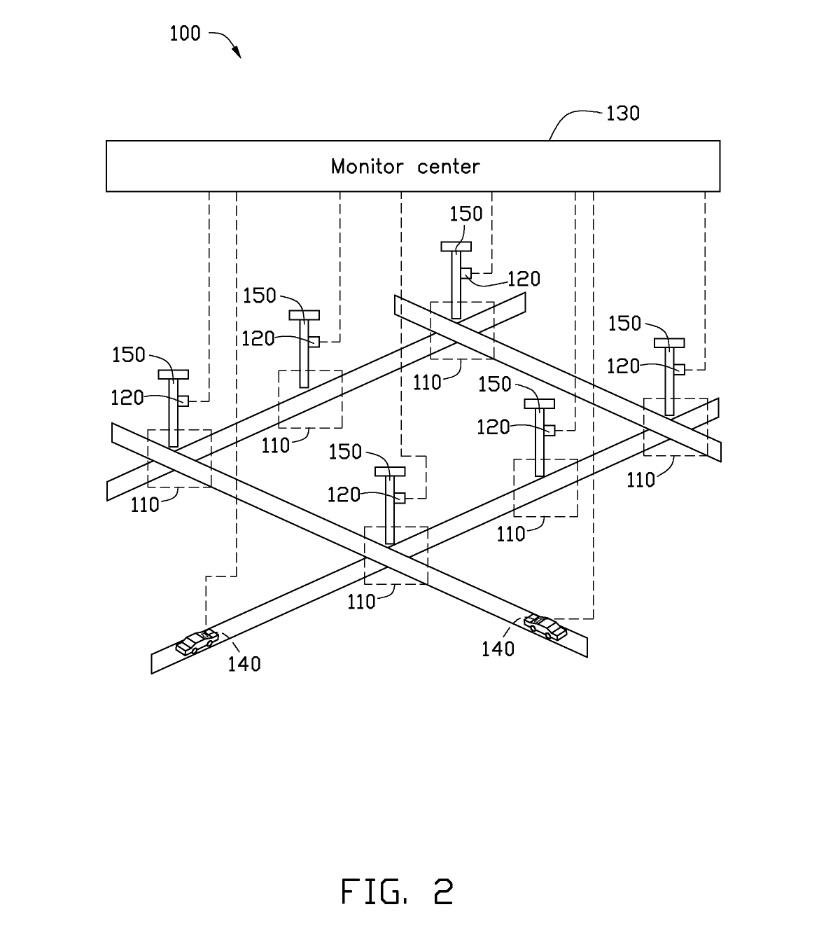

Referring to FIGS. 1-2, a roadway monitoring system 100 in accordance with one embodiment of the disclosure is shown. The roadway monitoring system 100 includes a plurality of monitoring regions 110, a plurality of cameras 120 positioned at the monitoring regions 110, a monitor center 130 and a plurality of portable electronic devices 140.

The monitoring regions 110 can be any locations in the roadway, such as traffic lights, school zones, hospital zones, intersection, locations with high traffic accidents or locations with frequent traffic violations.

The cameras 120 are positioned at each of the monitoring regions 110 to obtain instant images of the monitoring regions 110. The images obtained by the cameras 120 are transmitted to the monitor center 130 by a wireless network. The wireless network can be selected from one of the 3G (The Third Generation), WiMAX (Worldwide Interoperability for Microwave Access), and GPRS (General Packet Radio Service). In this embodiment, each camera 120 is positioned at a lamp pole of a street lamp 150. Preferably, the camera 120 can be rotated, zooming in or zooming out to get a better image of the monitoring region 110.

The monitor center 130 receives the images of the monitoring regions 110 obtained by the cameras 120, and determines a roadway condition in each of the monitoring regions 111. For example, according to the images of the monitoring regions 110, the monitor center 130 can determine whether there is a traffic jam in the road, and how serious the traffic jam is. If the cars in the road are almost stopped, there may be a serious traffic jam. If the cars in the road are moving slowly, there may be a medium traffic jam. If the cars in the road are moving in a normal speed, there may be no traffic jam happened. The monitor center 130 can include a map database. If a traffic jam happens in any of the monitoring regions 110, the monitor center 130 can generate a label in the map to indicate the happening of the traffic jam, therefore reminding the driver to select a better route to bypass the monitoring region 110 with traffic jam. Generally, speed of a car can be calculated in following steps. Firstly, a first image of the car is captured in a first time t1, wherein the car is in a first position. Secondly, a second image of the car is captured in a second time t2, wherein the car is in a second position. Compared the first image with the second image, and determined a distance D1 between the first position and the second position. Then, the speed V of the car can be determined by following expression: V=D1/(t2−t1). In an alternative embodiment, the information of how serious the traffic jam is can also be determined by a distance between two adjacent cars or a time interval of two adjacent cars passing trough the monitoring region 110.

Preferably, if a traffic accident is happened in any one of the monitoring regions 110, the cameras 120 can also capture images of the traffic accident and transmit the images to the monitor center 130. The monitor center 130 receives the images of the traffic accident and generates a warning to a person in charge, such as a policeman. In addition, the monitor center 130 can further label the information about the traffic accident in the map, and remind the drivers there is a traffic accident in that monitoring regions 110 and a traffic jam may happen in that position. So that the drivers can select another route to get to their destination.

The portable electronic devices 140 are taken by the drivers. With the portable electronic devices 140, the drivers can receive information about traffic jams or traffic accidents in the monitoring regions 110. Preferably, drivers can download the map with labels about the traffic jam or the traffic accident. According to indication of the map, the drivers can run avoiding regions with traffic jams or traffic accidents. In addition, without the cars going, the traffic jams in the monitoring region 110 can be mitigated. The portable electronic device 140 can be selected from a group consisting of mobile phones, PDA, and tablet computer. The portable electronic device 140 can further include an image capturing device. Therefore, when a traffic jam or a traffic accident happens in the roadside, the divers can also capture images of the traffic jam or the traffic accident, and upload the images to the monitor center 130. It means that even in the regions without the cameras 120, the information of traffic jams or traffic accident can be transmitted to the monitor center 130 immediately. Preferably, the drivers can input a starting location and a destination into the portable electronic device 140. The portable electronic device 140 will transmit the starting location and the destination to the monitor center 130. According to the traffic information, the monitor center 130 can determine one or more suitable routes and transmits the suitable routes back to the portable electronic device 140.

A method for monitoring a roadway condition is also provided. The method comprises following steps.

A plurality of cameras 120 is set at a plurality of monitoring region 110. The cameras 120 are configured to obtain images of the monitoring region 110.

A monitor center 130 is then provided. The monitor center 130 receives the images of the monitoring regions 110 and determines a traffic information in the monitoring regions 110 according to the images.

A portable electronic device 140 is provided. The portable electronic device 140 is communicated with the monitor center 130 and receives the traffic information from the monitor center 130.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A traffic monitoring system, comprising:
a plurality of cameras, respectively positioned at a plurality of monitoring regions to obtain images of the monitor regions;
a monitor center, receiving the images of the monitoring regions from the cameras, and determining a traffic information in the monitoring regions according to the images; and
a portable electronic device, communicated with the monitor center and receiving the traffic information from the monitor center.

2. The traffic monitoring system of claim 1, wherein the traffic information comprises information about that whether is a traffic jam happened and how serious the traffic jam is.

3. The traffic monitoring system of claim 1, wherein the cameras are positioned at a street lamp in the monitoring regions.

4. The traffic monitoring system of claim 1, wherein the portable electronic device comprises an image capturing device, the image capturing device is used to capture images in the roadway, and the captured images are transmitted to the monitor center.

5. The traffic monitoring system of claim 1, wherein the portable electronic device is selected from a group consisting of mobile phones, PDA, and tablet computer.

6. The traffic monitoring system of claim 5, wherein a starting location and a destination are inputted into the portable electronic device, and transmitted to the monitor center by the portable electronic device, according to the traffic information, the monitor center determining one or more suitable routes and transmitting the suitable routes back to the portable electronic device.

7. The traffic monitoring system of claim 1, wherein the monitor center comprises a map database, after determining the traffic information in the monitoring regions, and the monitor center generates a label in the map database to show the traffic information.

8. The traffic monitoring system of claim 7, wherein the monitor center further determines whether a traffic accident is happened in the monitoring regions according to the images of the monitoring regions, if a traffic accident happens, the monitor center will label the information of the traffic accident in the map database.

9. A method for monitoring a roadway condition, comprising following steps:
setting a plurality of cameras respectively at a plurality of monitoring region, the camera being configured to obtain images of the monitoring region;
providing a monitor center, the monitor center receiving the images of the monitoring regions and determining a traffic information in the monitoring regions according to the images; and
providing a portable electronic device, the portable electronic device being communicated with the monitor center and receiving the traffic information from the monitor center.

10. The method of claim 9, wherein the traffic information comprises information about that whether is a traffic jam happened and how serious the traffic jam is.

11. The method of claim 9, wherein the cameras are positioned at a street lamp in the monitoring regions.

12. The method of claim 9, wherein the portable electronic device comprises an image capturing device, the image capturing device is used to capture images in the roadway, and the captured images are transmitted to the monitor center.

13. The method of claim 9, wherein the portable electronic device is selected from a group consisting of mobile phones, PDA, and tablet computer.

14. The method of claim 13, wherein a starting location and a destination are inputted into the portable electronic device, and transmitted to the monitor center, according to the traffic information by the portable electronic device, the monitor center determining one or more suitable routes and transmitting the suitable routes back to the portable electronic device.

15. The method of claim 9, wherein the monitor center comprises a map database, after determining the traffic information in the monitoring regions, and the monitor center generates a label in the map database to show the traffic information.

16. The method of claim 15, wherein the monitor center further determines whether a traffic accident is happened in the monitoring regions according to the images of the monitoring regions, if a traffic accident happens, the monitor center will label the information of the traffic accident in the map database.
